(19) United States
(12) Patent Application Publication
(10) Pub. No.: US 2016/0260555 A1
(43) Pub. Date: Sep. 8, 2016

(54) COMPACT BUTTON WITH ILLUMINATED GRAPHIC

(71) Applicant: THOMSON LICENSING, Issy-les-Moulineaux (FR)

(72) Inventors: Darin Bradley RITTER, Indianapolis, IN (US); Mickey Jay HUNT, Camby, IN (US)

(73) Assignee: Thomson Licensing

(21) Appl. No.: 15/031,429

(22) PCT Filed: Oct. 21, 2014
(86) PCT No.: PCT/US2014/061555

§ 371 Date: Apr. 22, 2016

Related U.S. Application Data
(60) Provisional application No. 61/903,732, filed on Nov. 13, 2013.
(60) Provisional application No. 62/041,857, filed on Aug. 26, 2014.

(51) Int. Cl. H01H 13/02; H04N 21/41; H01H 13/14

(52) U.S. Cl. CPC H01H 13/023; H01H 13/14; H04N 21/41; H01H 2219/0621

(57) ABSTRACT

A button assembly includes a button structure (110) mounted to a frame (104) by a flexible hinge (108), where the button structure (110) has a clear external surface (102) and a graphical overlay (112) behind the external surface; and a light pipe (114) mounted to the button structure (110) and contacting 5 an actuator (118) that is configured to trigger when pressure is applied, where the light pipe (114) is configured to trigger the actuator (118) when pressure is applied to the button structure (110) and where the light pipe (114) is further configured to propagate light from a light source (116) to the button structure (110) to illuminate the graphical 10 overlay (112) and to minimize light leakage.

### CROSS-REFERENCE TO RELATED APPLICATIONS

This application claims the benefit of U.S. Provisional Application Ser. No. 61/903,732, filed Nov. 13, 2013 and U.S. Provisional Application Ser. No. 62/041,857, filed Aug. 26, 2014, which is incorporated by reference herein in its entirety.

### TECHNICAL FIELD

The present invention generally relates to buttons and, more specifically, to illuminated graphical actuation buttons.

### BACKGROUND

Consumer and market preference for electronic devices such as set top boxes, computers, game consoles, DVD players, CD player, etc., is to have such devices be compact. However, it is difficult to keep devices small, because set top boxes are required to perform more functions, which implies that they are contain more internal components.

One place this becomes apparent is in the use of buttons on the device. Such buttons are often made compact for aesthetic reasons and to inhibit electrostatic discharge, which can make it difficult to see a graphic on the button. Designs for such buttons are compact and coordinated with other features to optimize the space within the devices. Furthermore, manufacturing tolerances mean that there will inevitably be gaps in the design between the button and an enclosure.

Currently, the graphics are often too difficult to read without illumination. However, providing backlighting can result in unacceptable leaks of light visible when the illumination is activated, due to the gaps between the button and the enclosure.

Graphics on buttons are usually positioned behind another surface to protect them from rubbing off during repeated use. The front protective surface is captured in an opening in an enclosure and must be free to actuate when pressed by a customer.

To enable parts to be mass produced with the lowest cost possible, there are often minimum thicknesses and tolerances. Getting good graphic detail close enough to the front surface can therefore also be difficult.

### SUMMARY

A button assembly includes a button structure mounted to a frame by a flexible hinge, said button structure having a clear external surface and a graphical overlay behind the external surface; and a light pipe mounted to the button structure and contacting an actuator that is configured to trigger when pressure is applied, wherein said light pipe is configured to trigger the actuator when pressure is applied to the button structure and wherein said light pipe is further configured to propagate light from a light source to the button structure to illuminate the graphical overlay and to minimize light leakage.

A button assembly includes a button structure mounted to a frame by a flexible hinge, said button structure having a clear external surface and a graphical overlay behind the external surface; a button light pipe mounted to the button structure and contacting an actuator that is configured to trigger when pressure is applied, wherein said button light pipe has a button-facing surface that is larger than an actuator-facing surface, wherein said button light pipe is configured to trigger the actuator when pressure is applied to the button structure, and wherein said button light pipe is further configured to propagate light from a button light source to the button structure to illuminate the graphical overlay and to minimize light leakage; an illuminated indicator that comprises a cylindrical indicator light pipe that extends from an indicator light source and propagates light from the indicator light source to an exposed external surface; and a printed circuit board, wherein the actuator, the button light source, and the indicator light source are mounted to the printed circuit board.

A method for illuminating a button with minimal light leakage includes providing a light pipe in contact with an actuator; illuminating a graphical overlay by illuminating the light pipe with a light source, wherein the light pipe conveys light from the light source to a button structure to illuminate the graphical overlay and to minimize light leakage, wherein the button structure is mounted to a frame by a flexible hinge; and generating an actuator signal when the button structure is depressed, causing the light pipe to trigger the actuator.

The present principles include a set top box comprising an enclosure, a printed circuit board within the enclosure and the button assembly positioned over, under or adjacent to the printed circuit board within the enclosure.

### BRIEF DESCRIPTION OF THE DRAWINGS

The teachings of the present invention can be readily understood by considering the following detailed description in conjunction with the accompanying drawings, in which:

FIG. 1 is an exploded view of an illuminated button assembly according to the present principles within an electronic device such as a set top box;

FIG. 2 is a frontal view of an illuminated button assembly according to the present principles;

FIG. 3 is a perspective view of an illuminated button assembly according to the present principles;

FIG. 4 is an underneath perspective view of an illuminated button assembly installed in an enclosure according to the present principles within the electronic device; and

FIG. 5 is a flow chart highlighting the method for illuminating a button according to the present principles.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF PREFERRED EMBODIMENTS

Embodiments of the present invention provide illuminated graphical buttons using a light guide to minimize light leakage. A button assembly is provided that has a clear front lens that fits into an opening in an electrical enclosure. The front surface of the front lens is as thin as possible to maximize visibility. A sheet overlay of plastic with translucent and opaque graphics is assembled inside the clear front lens. The front lens is fixed to the movable portion of an opaque plastic frame. The opaque plastic frame is a single molded piece and has a center portion connected by flexible hinges to a rigid outer frame that mounts to the surrounding enclosure.

The opaque plastic frame has light blocking side walls that telescope into the inside perimeter of the clear front lens. These walls press against the perimeter of the rear surface of the graphics sheet overlay and create a light-proof barrier. The overlap of the telescoping side walls of the opaque plastic frame and the sheet overlay prevents visible light leaks when the illumination is activated. Because the graphics sheet overlay fits inside the clear front lens, the graphics are very close to the front surface and are clearly visible even without the rear illumination.

A translucent light pipe is fixed to the opaque plastic frame and presses against the back of the sheet overlay. The fixation may be accomplished by heatstaking or press fitting. Light from, e.g., a light emitting diode (LED) on a printed circuit board (PCB) is transmitted through the light pipe to illuminate the back of the sheet overlay. The light pipe also translates motion from the customer pressing the front lens of the button assembly to an actuator of a switch.

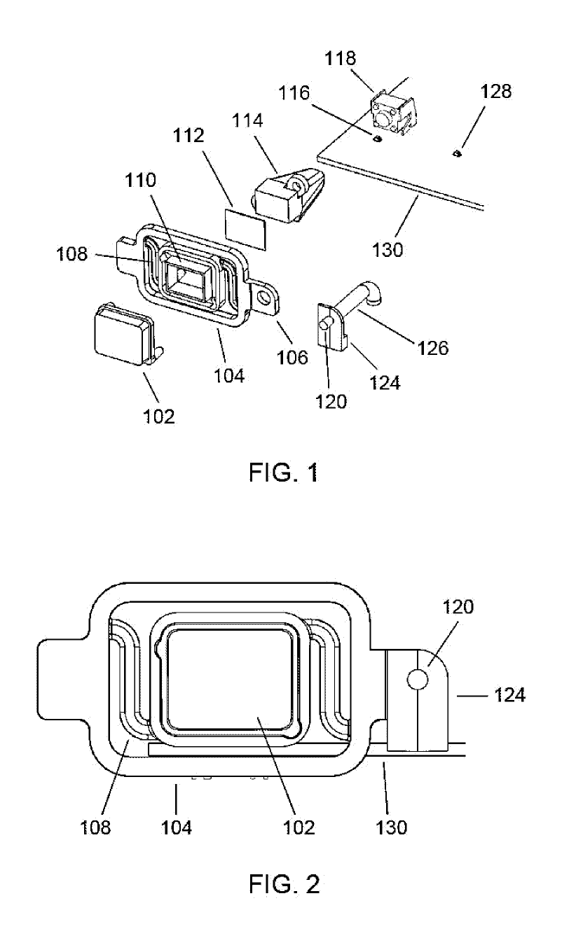

Referring now in specific detail to the drawings in which like reference numerals identify similar or identical elements throughout the several views, and initially to FIG. 1, an exploded view of an illuminated graphical button in accordance with the present embodiments is shown. A clear front lens and button 102 is shown.

The button and lens 102 are externally accessible and are configured to withstand the pressure of a user's finger when pressing the button. The button 102 is mounted on a button support piece 110 which, in turn, is connected to a frame 104 by a flexible hinge 108. The button 102 may be fixed to the button support piece 110 by e.g., heatstaking or press fitting. The button support piece 110 is located within an open center region of the frame 104 and the flexible hinge 108 may be any suitable structure that allows motion of the button support piece 110 transverse to a plane of the frame 104. The frame 104 is fixed to an enclosure of the device by, e.g., heatstaking or press fitting. It is contemplated that the hinge 108 may be formed as shown, with thin pieces of material connecting the button support piece 110 to the frame 104, but it is also contemplated that the hinge 108 may be formed from, e.g., a spring or elastic material. The button 102 may have alignment rods extending rearward from peripheral edges that engage holes in the button support piece 110.

A sheet overlay 112, which is contemplated as being a translucent sheet with graphics, can be positioned on the interior side of the button 102 and centered around the button support piece 110. A light pipe 114 is provided which can be a solid transparent or translucent material that transmits light and which provides a structural, mobile mechanical connection between the button 102 and a switch actuator 118. When the button 102 is pressed, pressure is applied via the light pipe 114 to the switch actuator 118. The light pipe 114 is therefore positioned between the sheet overlay 112 and the actuator 118. The light pipe 114 may be fixed into place with, e.g., heatstaking or press fitting. In one specifically contemplated embodiment, the light pipe 114 has an actuator-contact end facing the actuator 118 that is narrow and a button-facing end that that extends from the narrow end and widens as it approaches the button 102 to produce a tapered shape. The light pipe 114 may be conical or may have a rectilinear cross section. The switch actuator 118 may include an actuator on a vertical surface that faces a front wall of a device enclosure.

A button light source 116 is mounted on a PCB 130 with the actuator 118 and may be, e.g., an LED or any other suitable light-emitting device. The light pipe 114 is positioned over or directly on the light source 116 and redirects emitted light toward the button 102 with little or no leakage. Light from the button light source 116 enters the light pipe 114 and reflects off of interior surfaces to propagate toward the button 102. Additionally, if the light pipe 114 is translucent, the light may reach the button by scattering, rather than reflection off of interior surfaces. The surface of the wide end of the light pipe 114 may be textured to help with light distribution and to obscure the shape of the button light source 116.

Optionally, an additional light source 128 may be provided on the PCB 130. This light source may function as an indicator light for, e.g., a status indicator that shows that some action is being performed. For example, the additional light source may represent a “record” function to indicate that the device is storing data. As above, the additional light source 128 may be an LED or any other appropriate light emitting device. A light pipe 126 rests over or on the additional light source and redirects light to a visible indicator 120 that fits through an aperture 106 in the button frame 104. A support flange 124 may connect with the frame 104 and a device enclosure to provide support to the light pipe 126. It is contemplated that the light pipe 126 may have a cylindrical horizontal portion that runs rearward to a bent section that makes contact with the additional light source 128.

Referring now to FIG. 2, an enlarged diagram of the frame 104 is shown. The button frame 104 is attached to the support flange 124, which in turn is attached to the PCB 130.

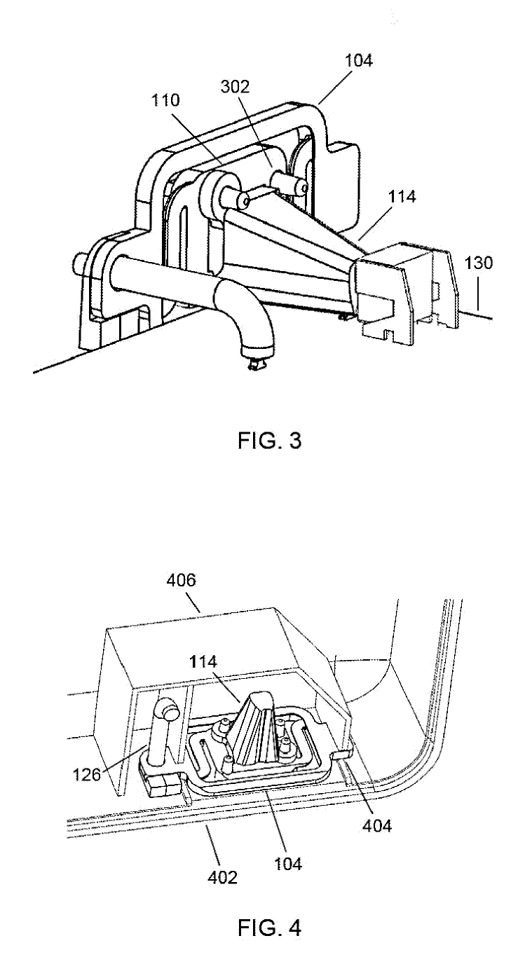

Referring now to FIG. 3, a rear perspective view of the button assembly is shown. In particular, FIG. 3 illustrates how the button support 110 may be connected to the button 102 (not shown) and the light pipe 114 using heat stakes 302. The heatstakes 302 are melted to secure the components in place.

Referring now to FIG. 4, the button assembly is shown installed in an enclosure 402 of the electronic device. The frame 104 of the assembly engages with a slot 404 of a housing 406. When the enclosure is closed, the button assembly is positioned over the PCB 130 such that the light pipes 114 and 126 are above the respective light sources 116 and 128 and such that the button light pipe 114 contacts the actuator 118.

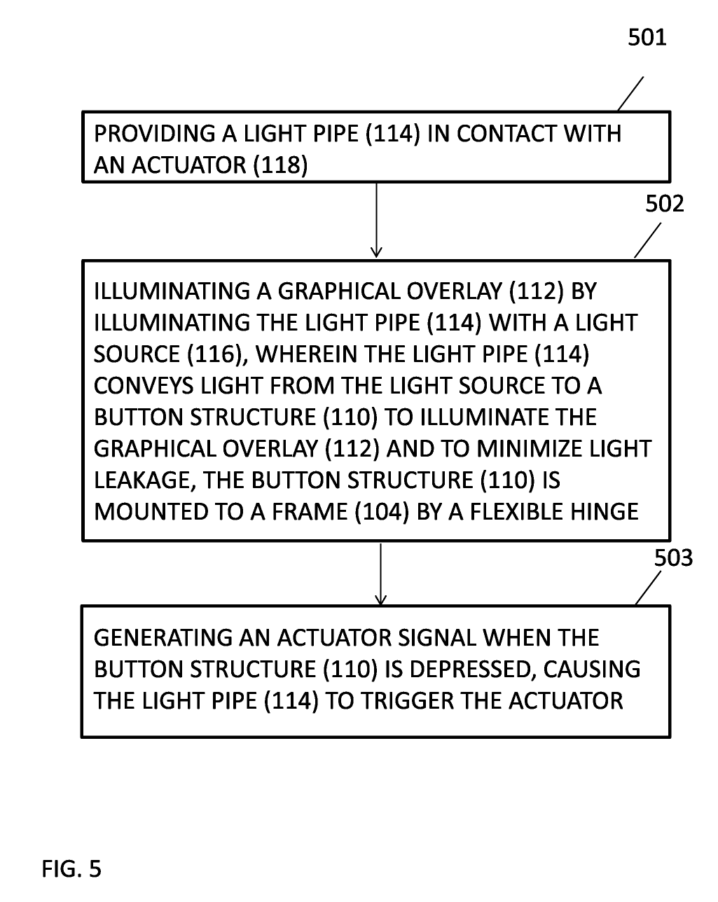

The method for illuminating a button with minimal light leakage in described in FIG. 5. Step 501 includes providing a light pipe in contact with an actuator. Step 502 includes illuminating a graphical overlay by illuminating the light pipe with a light source, wherein the light pipe conveys light from the light source to a button structure to illuminate the graphical overlay and to minimize light leakage, wherein the button structure is mounted to a frame by a flexible hinge. Step 503 includes generating an actuator signal when the button structure is depressed, causing the light pipe to trigger the actuator.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of this disclosure.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A set top box comprising:
an enclosure (402);
a printed circuit board (130) within the enclosure; and
a button assembly positioned over the printed circuit board within the enclosure, the button assembly comprising:
a button structure (110) mounted to a frame (104) by a flexible hinge (108), said button structure having a clear external surface (102) and a graphical overlay (112) behind the external surface; and
a light pipe (114) mounted to the button structure (110) and contacting an actuator (118) that is configured to trigger when pressure is applied, wherein said light pipe (114) is configured to trigger the actuator (118) when pressure is applied to the button structure (110) and wherein said light pipe (114) is further configured to propagate light from a light source (116) to the button structure (110) to illuminate the graphical overlay (112) and to minimize light leakage.

2. The set top box of claim 1, wherein said light pipe has a button-facing surface that is larger than an actuator-facing surface.

3. The set top box of claim 2, wherein said light pipe has a continuous taper between the button-facing surface and the actuator facing surface.

4. The set top box of claim 3, wherein said light pipe is conical.

5. The set top box of claim 3, wherein said light pipe has a rectangular cross section.

6. The set top box of claim 1, wherein the actuator and the light source are mounted to the printed circuit board.

7. The set top box of claim 1, wherein the light source is a light emitting diode and wherein the light pipe contacts the light source.

8. The set top box of claim 1, wherein the light pipe is translucent to scatter light and obscure a shape of the light source.

9. The set top box of claim 1, further the button assembly comprising an illuminated indicator that comprises an indicator light pipe that extends from an indicator light source and propagates light from the indicator light source to an exposed external surface.

10. The set top box of claim 9, wherein the indicator light pipe has a cylindrical cross section.

11. The set top box of claim 1, wherein the light pipe is mounted to the button structure by heat stakes.

12. A button assembly, comprising:
a button structure (110) mounted to a frame (104) by a flexible hinge (108), said button structure (110) having a clear external surface (102) and a graphical overlay (112) behind the external surface; and
a button light pipe (114) mounted to the button structure (110) and contacting an actuator (118) that is configured to trigger when pressure is applied, wherein said button light pipe (114) has a button-facing surface that is larger than an actuator-facing surface, wherein said button light pipe is configured to trigger the actuator (118) when pressure is applied to the button structure (110), and wherein said button light pipe (114) is further configured to propagate light from a button light source (116) to the button structure (110) to illuminate the graphical overlay (112) and to minimize light leakage.

13. The button assembly of claim 12, wherein the button assembly comprises:
an indicator (120) that comprises a cylindrical indicator light pipe (126) that extends from an indicator light source (128) and propagates light from the indicator light source (128) to an exposed external surface;
wherein the actuator (118), the button light source (116), and the indicator light source (128) are mounted to a printed circuit board.

14. The button assembly of claim 12, wherein said light pipe has a continuous taper between the button-facing surface and the actuator facing surface.

15. The button assembly of claim 140, wherein said light pipe is conical.

16. The button assembly of claim 14, wherein said light pipe has a rectangular cross section.

17. The button assembly of claim 12, wherein the light source is a light emitting diode and wherein the light pipe contacts the light source.

18. The button assembly of claim 12, wherein the light pipe is translucent to scatter light and obscure a shape of the light source.

19. The button assembly of claim 12, wherein the light pipe is mounted to the button structure by heat stakes.

20. A method for illuminating a button with minimal light leakage, comprising:
providing a light pipe (114) in contact with an actuator (118);
illuminating a graphical overlay (112) by illuminating the light pipe (114) with a light source (116), wherein the light pipe (114) conveys light from the light source to a button structure (110) to illuminate the graphical overlay (112) and to minimize light leakage, wherein the button structure (110) is mounted to a frame (104) by a flexible hinge; and
generating an actuator signal when the button structure (110) is depressed, causing the light pipe (114) to trigger the actuator.
